(19) United States
(12) Patent Application Publication
(10) Pub. No.: US 2005/0132893 A1
(43) Pub. Date: Jun. 23, 2005

(54) Process for single-stage heat treatment and grinding of coffee beans

(75) Inventors: Vijay K. Arora, Lake Forest, IL (US); Gerald Wasserman, Hoboken, NJ (US); Dennis F. Hayes, Brewster, NY (US); Manoj Shah, Lindenhurst, IL (US)

Correspondence Address: KRAFT / FETF, 120 S. LASALLE STREET, SUITE 1600, CHICAGO, IL, 60603-3406, US

(73) Assignee: Kraft Foods Holdings, Inc., Northfield, IL (US)

(21) Appl. No.: 10/736,595

(22) Filed: Dec. 17, 2003

(51) Int. Cl. A47J 31/00

(52) U.S. Cl. 99/287

(57) ABSTRACT

A single-stage process for drying, roasting, and grinding of green coffee beans in a single unit operation in a continuous manner. Heat-treated and ground coffee beans having savory flavor and aroma are achieved in a unique process described herein that combines all these different treatments in a single-stage operation.

### FIELD OF THE INVENTION

The invention generally relates to a process for single-stage drying, roasting and grinding of coffee beans and similar particulate edible materials.

### BACKGROUND OF THE INVENTION

Coffee beans are derived from coffee cherries produced by the coffee plant. Once coffee cherries have been picked, the fleshy pulp is removed to expose the coffee bean (the seed). There are two general methods of cleaning coffee beans: the “dry” process and the “wet” process. In the dry process, ripe coffee cherries are left to dry in the sun until the shriveled husk can be cracked open. The wet method involves soaking the coffee cherries and removing the pulp with rollers. The husk is then removed by soaking the beans again in natural enzymes, then washing and partial drying. The green coffee beans obtained are then graded and packed.

The green coffee beans are roasted before consumption to develop the characteristic and desired flavor and aroma of the coffee product. When roasted, chemical reactions occur within the coffee beans that transform the beans into the desired state of pyrolysis. The roasted coffee beans acquire a darker hue as volatile coffee oil is released during the roasting process. Roasting is a sensitive process requiring skill in generating the coffee flavors without adversely affecting the balance of taste. Uniform heating of the coffee beans is important in this respect, so that the coffee beans experience essentially the same heat history during roasting. In previous efforts to provide more uniform heating of the coffee beans during roasting, coffee beans have been roasted in large revolving drums, or in fluidized beds and the like, such that the beans are heated while suspended in air.

After roasting and at some point before consumption, the coffee beans are ground into smaller particles of generally uniform size to facilitate extraction of flavor components from the coffee product during brewing. Some roasted coffee beans are sold intact after roasting, and they are ground by consumers themselves before brewing.

However, there is a large market and need for preground roasted coffee beans. Coffee bean processors grind roasted coffee beans and pack the ground product in airtight pouches or cans into which inert gas is commonly injected to displace oxygen before sealing the package, so that flavor loss in the ground coffee beans from oxidation is minimized. The preground coffee products offer the consumer added convenience as they eliminate the need to grind the coffee beans or need for equipment for that purpose.

Roasted coffee beans also are ground by coffee bean processors for use in the manufacture of some instant coffee products. In making such instant coffee products, roasted coffee beans are ground and then brewed in relatively large production quantities, and the brewed product is either freeze-dried or spray-dried to shelf-stable moistures in granular or powder form. Consequently, commercial processes are used and needed by coffee bean processors for both roasting and grinding green coffee beans in one unit operation.

Moreover, the coffee bean processing business is competitive, so economic factors such as capital costs, operation costs and production yields are important. An arrangement for making roasted ground coffee in fewer process steps and with less equipment requirements would be beneficial and desirable. The present invention addresses the above and other needs in an efficient and economically-feasible manner.

### SUMMARY OF THE INVENTION

This invention provides a process for drying, roasting, and grinding green coffee beans in a single unit operation. This process combines and executes all these different thermal and physical coffee bean treatments in a single-stage operation that can be conducted in a continuous manner. The heat-treated and ground coffee beans obtained by this single-stage process have savory coffee flavor and aroma.

In one embodiment of this invention, a coffee bean heat treatment and grinding process is provided in which compressed heated air and wet green coffee beans are separately introduced into an enclosure that includes a truncated conical shaped section. After introduction, the compressed heated air spirals along a downward path through the enclosure until it reaches a lower end thereof. The air flows back up from the lower end of the enclosure in a central region thereof until exiting the enclosure via an exhaust duct. The green coffee beans are separately introduced into an upper end of the enclosure, and they become entrained in the heated air spiraling downward through the enclosure until reaching the lower end of the enclosure.

During this movement of the coffee beans from the upper end of the enclosure down to the lower end thereof, the coffee beans are thermally and physically processed in mutually beneficial ways. The green coffee beans are dehydrated and roasted by the heated air in which they are suspended in such a dynamic air flow system. During the same unit operation, the coffee beans are ground from violent collision interactions occurring amongst the coffee bean particles contained in the high-velocity cyclonically pressurized air and/or from the centrifugal force of the vortex moving the beans forcefully against inner walls of the enclosure, which disrupt the physical structure and causes attrition of the beans. The outcome is that significant amounts of the introduced green coffee beans are dried, roasted, and ground before reaching a lower end of the enclosure.

Consequently, a solid particulate product including dried, roasted and ground coffee beans is discharged and recovered from the lower end of the enclosure, while air and moisture vapor released from the coffee beans from drying and roasting is exhausted from the system via the exhaust duct. In one particular embodiment, the enclosure is a two-part structure including an upper cylindrical shaped enclosure in which the compressed heated air and wet green coffee beans are separately introduced, and the cylindrical enclosure adjoins and fluidly communicates with a lower enclosure having the truncated conical shape that includes the lower end of the overall structure from which the processed feed material is dispensed.

The single-stage process for drying, roasting, and grinding of green coffee beans in a continuous manner in a single unit operation according to embodiments of this invention offers numerous advantages over conventional schemes for roasting and grinding coffee beans. For one, there is the elimination of the need for conducting separate drying, roasting, and grinding processes in different equipment such as conventionally used in processing wet green coffee beans. Additionally, the process of this invention can be operated in a continuous mode as the compressed heated air is continually exhausted from the system after entraining the coffee beans downward through the enclosure to its lower end where they are deposited, and roasted and ground coffee bean product material can be withdrawn from the lower end of the enclosure in an air-tight manner, such as by using a rotary air-lock. These advantages reduce process complexity, production time, and production costs. Also, product quality enhancements are attained. The drying, roasting and grinding of the wet coffee beans in the same equipment can enhance flavor and aroma generation as compared to roasting and grinding them in separate processes performed in separate equipment. In a further embodiment, a higher yield and more uniform product color development is made possible as part of grinding inside the roasting enclosure by controlling particle size distribution via screening or other classification procedure performed on the product stream and recycling coarser fraction coffee beans needing more grinding.

For purposes herein, “drying” means dehydrating, i.e., a reduction in moisture content; “roasting” means heating a fruit bean sufficient to induce pyrolysis; and “grinding” means crushing, pulverizing, abrading, wearing, or rubbing a particle to break the particle down into smaller particles and/or liberate smaller particles from the particle, and includes mechanisms involving contact between moving particles, and/or between a moving particle and a static surface.

Although this invention is illustrated for processing coffee beans, it will be appreciated that the methods and equipment arrangements of this invention are generally applicable to other edible fruit beans, such as cocoa beans.

### BRIEF DESCRIPTION OF THE DRAWINGS

Other features and advantages of the present invention will become apparent from the following detailed description of preferred embodiments of the invention with reference to the drawings, in which:

FIG. 1 is a schematic view of a system useful for processing coffee beans according to an embodiment of this invention.

FIG. 2 is a cross sectional view of the cyclone unit used in the processing system illustrated in FIG. 1.

The features depicted in the figures are not necessarily drawn to scale. Similarly numbered elements in different figures represent similar components unless indicated otherwise.

### DETAILED DESCRIPTION OF PREFERRED EMBODIMENTS

The invention is preferably embodied in a single-stage process for drying, roasting, and grinding of green coffee beans in one unit operation. In general, the process is implemented on a cyclonic type system that may be operated in a manner whereby the coffee beans may be thermally and physically acted upon at the same time within the same processing unit in a beneficial manner.

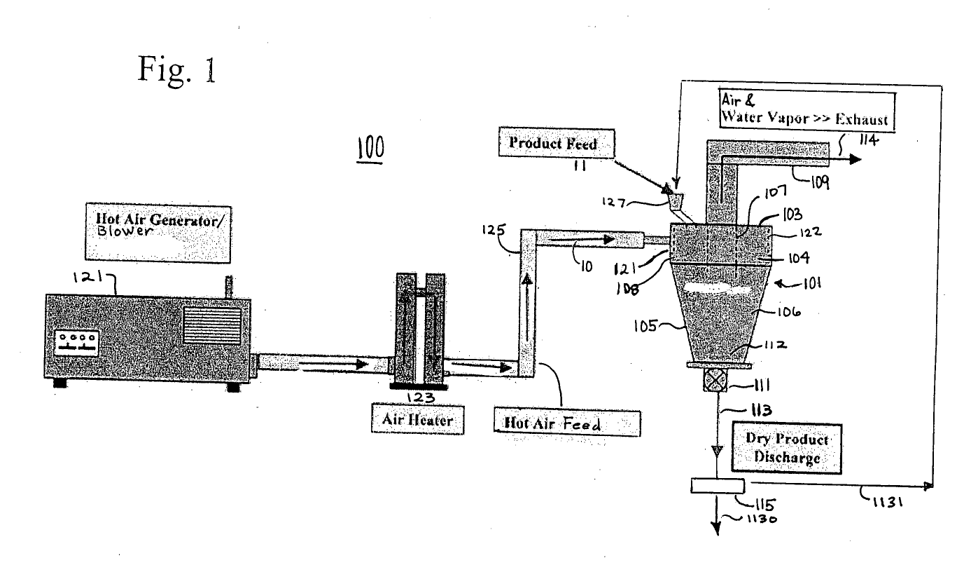

Referring to FIG. 1, an exemplary system 100 for handling green coffee beans according to a process embodiment of this invention is shown. Cyclone 101 is a structural enclosure comprised of two fluidly communicating sections: an upper cylindrical enclosure 103 defining a chamber 104; and a lower truncated conical shaped enclosure 105 that defines a cavity 106. Both the upper and lower enclosures are annular structures in which solid wall or shell encloses an interior space. For purposes herein, the terminology “enclosure” means a structure that encloses a chamber, cavity, or space from more than one side.

Compressed heated air 10 and wet green coffee beans 11 are separately introduced into the cyclone 101 at the upper enclosure 103. The processed coffee beans are discharged as a solid particulate 113 from the lower end 112 of the cyclone 101. A valve mechanism 111, such as a rotary valve or rotary air-lock, is shown that permits extraction of dried, roasted ground coffee product from the cyclone without interrupting continuous operation of the system and which minimizes leakage of the heated air from the cyclone 101. If the cyclone 101 is operated without an air-lock or the like at the bottom discharge end of the cyclone 101, the system generally will run less efficiently as heated air will be forced out of the lower end 112, which will need to be compensated for in the air feed rate. Air, and moisture vapor released from the coffee beans during heat treatment within the cyclone 101, is exhausted as exhaust gases 114 from the cyclone via sleeve 107 and exhaust duct 109. Some silver skin (bean chaff) is liberated from the coffee beans during their processing in the cyclone and gets eliminated with the exhaust gas stream 114. Sieving device 115 is optional, and is described in more detail later herein. Generally, it can be used to recycle oversize product in particulate product 113 back into the coffee bean feed that is introduced into the cyclone 101.

To introduce the compressed heated air 10 into cyclone 101, an air pressurizing mechanism 121, such as a blower or air compressor, generates a high volume, high velocity compressed air stream that is conducted via hot air ducting 125 through an air heater 123, and from there is introduced into upper enclosure 103 of cyclone 101. The compressed heated air 10 is introduced into chamber 104 substantially tangentially to an inner wall 108 of the upper enclosure 103. This can be done, for example, by directing the heated air stream 10 to a plurality of holes 121 circumferentially spaced around and provided through the wall 108 of the upper enclosure 103 through which the heat stream is introduced. Deflection plates 122 can be mounted on inner wall 108 of upper enclosure 103 for deflecting the incoming stream of heated air into a direction substantially tangential to the inner wall 108 according to an arrangement that has been described, for example, in U.S. patent application No. 2002/0027173 A1, which descriptions are incorporated herein by reference.

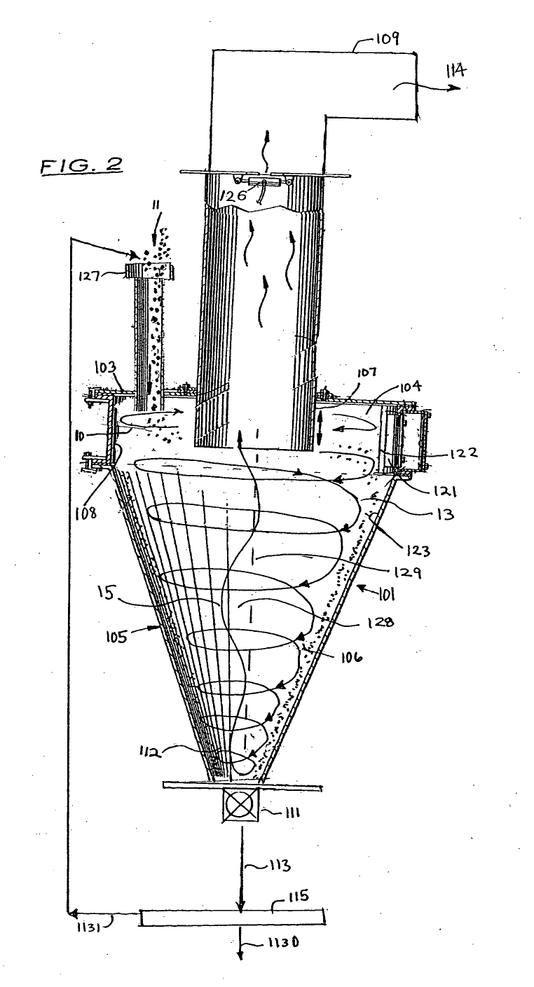

The introduced air 10 is further pressurized cyclonically in the chamber 104 and cavity 106. Due to the centrifugal forces present in the cyclonic environment, the pressure nearer the outer extremities of the cavity 106 is substantially greater than atmospheric pressure, while the pressure nearer the central axis of the cavity 106 is less than atmospheric pressure. As shown in FIG. 2, after being introduced into upper enclosure 103, the compressed heated air 10 spirals along a large downward path as a vortex 13 through the upper enclosure 103 and the lower conical shaped enclosure 105 until it reaches a lower end 112 thereof. Near the lower end 112 of the cavity 106 defined by the inner walls 123 of lower enclosure 105, the downward direction of the air movement is reversed, and the air (and moisture vapor released from the coffee beans during heat treatment within the cyclone 101) whirls back upwardly as a smaller vortex 15 generally inside the larger vortex 13. The smaller vortex 15 flows back up from the lower end 112 of the lower enclosure 105 in a central region 128 located proximately near the central axis 129 of the cyclone 101 and generally inside the larger vortex 13. The smaller vortex 15 flows upward until exiting the enclosure via sleeve 107 and then exhaust duct 109.

A vortex breaking means (not shown) optionally can be interposed below or inside the lower end 112 to encourage the transition of the larger vortex 13 to the smaller vortex 15. Various vortex breaking arrangements for cyclones are known, such as the introduction of a box-shaped enclosure at the bottom of the conical enclosure.

The green coffee beans 11 are separately introduced into upper enclosure 103. The introduced coffee beans drop gravitationally downward into chamber 104 until they become entrained in the heated air vortex 13 within cyclone 101. Preferably, the coffee beans are introduced into upper enclosure 103 in an orientation such that they will fall into the cyclonic vortex 13 generated within cyclone 101, where located in the space between the sleeve 107, and inner wall 108 of the upper enclosure 103. This feed technique serves to minimize the amount of coffee beans that may initially fall into extreme inner or outer radial portions of the vortex where the cyclonic forces that the coffee beans experience may be lower.

The entrained coffee beans travel in the vortex 13 of heated air that spirals downward through the lower enclosure 105 until reaching the lower end 112 of the lower enclosure 105. During this downward flow path, the green coffee beans are dehydrated and roasted by the heated air in which they are suspended in such a dynamic air flow system. They also are ground during the downward flow path. The various dehydration, roasting, and grinding effects on the coffee beans may occur at different respective times, and/or several of the effects may occur simultaneously at a particular point or points in time, during the downward flow path of the coffee beans through the cyclone. It is thought that the pressure-gradient and coriolis forces across and the collision interaction between the coffee bean particles entrained in the high-velocity cyclonically pressurized air are violently disruptive to the physical structure of those beans. Alternatively, or in addition thereto, the centrifugal force of the vortex moves the beans forcefully against inner walls 108 and 123 of the enclosure. Either or both modes of collisions are thought to bring about comminuting (grinding) of the coffee beans concurrent with drying and roasting of them. As a result, during this movement of the coffee beans from the upper enclosure 103 down to the lower end 112 of the lower enclosure 105, the coffee beans are thermally and physically processed in mutually beneficial ways.

In a further embodiment of the invention, the discharged solid particulate product 113 can be screened, such as using a sieve, such as a screen sieve or other suitable particulate separation/classifying mechanism 115, to sort and separate the finer fraction of ground coffee beans 1130 in the solid particulate product 113 that have particle sizes meeting a size criterion, such as being less than a predetermined size, which are suitable for post-grinding processing, from the coarser product fraction 1131. The coarser (oversize) product fraction 1131 can be recycled by re-introducing it into the upper enclosure of the cyclone for additional processing therein. A conveyor (not shown) could be used to mechanically transport the recycled material back to feed introducing means 127 or other introduction means in upper enclosure 103 of cyclone 101. Also, even if an acceptable size of grind coffee beans is obtained, if a deeper roast is desired, those ground coffee beans can be re-introduced into the system to receive additional roasting and grinding.

It will be appreciated that sleeve 107 can be controllably moved up and down to different vertical positions within cyclone 101. In general, the lower sleeve 107 is spaced relative to the cavity 106, the smaller the combined total volume of the cyclone 101 which is available for air circulation. Since the volume of air being introduced remains constant, this reduction in volume causes a faster flow of air, causing greater cyclonic effect throughout cavity 106 and consequently causing the beans being ground to circulate longer in the chamber 104 and the cavity 106. Raising the sleeve 107 generally has the opposite effect. For a given feed and operating conditions, the vertical position of sleeve 107 can be adjusted to improve process efficiency and yield.

Also, a damper 126 can be provided on exhaust duct 109 to control the volume of air permitted to escape from the central, low-pressure region of cavity 106 into the ambient atmosphere, which can affect the cyclonic velocities and force gradients within cyclone 101.

By continually feeding coffee beans into cyclone 101, a continuous throughput of roasted and grind coffee bean product material 113 is obtained. A non-limiting example of a commercial apparatus that can be operated in a continuous manner while processing coffee beans according to processes of this invention is a WINDHEXE apparatus, manufactured by Vortex Dehydration Systems, LLC, Hanover Md., U.S.A. Descriptions of that type of apparatus are set forth in published U.S. patent application No. 2002/0027173 A1, which descriptions are incorporated in their entirety herein by reference.

The cyclonic system 100 provides very high heat transfer rates from hot air to beans for roast flavor and color development, and mechanical energy to crack and granulate roasted beans as they descend through the conical section of the dryer. The coffee bean product exiting the cyclone 101 exhibits roasted and ground coffee flavors and aromas and appearance. The one-stage process offers numerous advantages over conventional schemes for roasting and grinding coffee beans in terms of providing a satisfactory quality ground coffee product while eliminating the need for separate drying, roasting, and grinding processes and equipment that are conventionally used in processing wet green flavor modified beans.

In one non-limiting process scheme according to the invention for processing coffee beans, the introduction of the heated air comprises supplying compressed heated air at a pressure within the range of from about 10 psig to about 100 psig, particularly from about 15 psig to about 60 psig. The heated air is introduced into the cyclone at a temperature within the range of about 300° F. to about 500° F., particularly about 375° F. to about 425° F. The volumetric introduction rate of the heated air into the cyclone is within the range of from about 1,000 cubic feet per minute to about 10,000 cubic feet per minute, particularly from about 1,500 cubic feet per minute to about 3,000 cubic feet per minute.

The feed rate of the coffee beans can vary, but generally will be in the range of about 1 to about 5 pounds per minute for about a 1 to about a 10 foot diameter (maximum) cyclone.

The green coffee beans that can be used in the process of this invention can be derived from coffee arabica, coffee canephora (robusto), or other varieties of coffee plants that bear seeded fruit. The green coffee beans optionally can be flavor-modified before processing according to embodiments of this invention. The green coffee beans can have sizes and geometries consistent with commercially available green coffee beans. In one embodiment, the green coffee beans used as the feed material generally contain about 25 wt. % to about 35 wt. % moisture when introduced into the cyclone 101 of system 100, while the dried, roasted and ground coffee bean product generally contains about 3 wt. % to about 5 wt. % moisture. Ground coffee beans are obtained by the processes of this invention having commercially useful particle sizes. In one embodiment, the ground coffee beans obtained by processing according to this invention generally may have an average particle size of about 0.1 mm to about 4 mm. In one embodiment, the solid particulate product obtained as the bottoms of the cyclone comprise at least about 50% ground coffee beans have an average particle size of about 0.1 mm to about 1 mm.

Although this invention has been illustrated for processing coffee beans, it will be appreciated that the methods and equipment arrangements of this invention are generally applicable to other agro-beans such as cocoa beans in general.

The Examples that follow are intended to illustrate, and not limit, the invention.

All percentages are by weight, unless indicated otherwise.

### EXAMPLES

Wet green coffee beans from a green flavor modified process (moisture content, 30%) were fed into each of two different sizes of a WINDHEXE apparatus for circular vortex air flow material grinding. Each WINDHEXE apparatus was manufactured by Vortex Dehydration Systems, LLC, Hanover, Md., U.S.A. The basic configuration of that type of apparatus is described in published U.S. patent application No. 2002/0027173 A1, and reference is made thereto. The process unit had four inlet ports equidistantly spaced around the upper portion of the apparatus through which the compressed air stream was concurrently introduced.

A two-foot diameter and a four-foot diameter WINDHEXE apparatus were tested. Two test runs were conducted on the 2-foot diameter apparatus, and one on the four-foot apparatus. The diameter size refers to the chamber size of the enclosure into which air and coffee bean introductions were made. The conditions of these tests are described below.

For all tests, the feed rate of wet green coffee beans was set for an approximate discharge of 3 pounds solid product per minute, and approximately 20-25 pounds of green coffee bean material was tested in each size of apparatus. The wet green coffee beans were loaded into a hopper that directly fed onto a three-inch belt conveyor that fed into the WINDHEXE apparatus. For all tests, the total amount of air being used was approximately 2,500 cubic feet per minute (cfm).

Test 1:

Testing was performed in the 2-foot diameter WINDHEXE apparatus with compressed air introduced at 410° F., a heated air introduction rate of 2,500 cfm and pressure of 25 psig. About 20 pounds of wet green beans product were introduced into the apparatus. The coffee product exiting the apparatus was lightly roasted and coarsely ground. The product exhibited distinct coffee notes and appearance.

The coffee bean product from the first run (i.e., lightly roasted and coarsely ground) was sent through the apparatus again and acquired a darker roasted product with finer grind size.

Test 2:

Additional testing was performed in the 2-foot diameter WINDHEXE apparatus with compressed air introduced at 400° F., 2,500 cfm and 50 psig (input power 437 KWH). About 25 pounds of wet green beans product were introduced into the apparatus. The process converted a portion of the coffee beans into a dry and powder-like material, which was recovered at the lower discharge end of the apparatus. The ground particles had a roasted coffee aroma. Some beans stayed relatively intact (i.e., little or nominal grinding), but exited at reduced moisture content (i.e., they were dried).

It will be appreciated that the partially dried oversized beans discharged with the solid particulate material at the lower end of the apparatus can be separated from the finer sized fraction by sieving techniques, and then the coarser fraction can be continuously recycled to the apparatus for reprocessing in the apparatus until dried and ground to the desired size.

Test 3:

Separate testing was performed in the 4-foot diameter WINDHEXE apparatus with compressed air introduced at 400° F., 2,500 cfm and 50 psig (input power 437 KWH). About 25 pounds of product were introduced into the 4-foot cyclone. The process converted a portion of the coffee beans into a dry and powder-like material. Some beans stayed intact, but at reduced moisture. The ground particles had a roasted coffee aroma.

These tests demonstrated that wet green coffee beans were successfully roasted, ground and dried in a single process operation and in a single piece of equipment. The feed rate of wet green coffee beans could be managed to control finished product granulation and moisture.

While the invention has been particularly described with specific reference to particular process and product embodiments, it will be appreciated that various alterations, modifications and adaptations may be based on the present disclosure, and are intended to be within the spirit and scope of the present invention as defined by the following claims.

1. A coffee bean heat treatment and grinding process, comprising:
introducing compressed heated air into an enclosure that includes a truncated conical shaped section, wherein the heated air spirals along a downward path through the enclosure, including the conical section, to a lower end thereof, and the heated air reaching the lower end flows back up and exits the enclosure via an exhaust outlet;
introducing into the enclosure green coffee beans which are entrained in the heated air spiraling downward through the enclosure, wherein at least a portion of the green coffee beans are dried, roasted, and ground before reaching the lower end of the enclosure;
discharging a solid particulate product including dried, roasted and ground coffee beans from the lower end of the enclosure.

2. The process of claim l, wherein the green coffee beans contain about 25 wt. % to about 35 wt. % moisture when introduced; and the dried, roasted and ground coffee beans contain about 3 wt. % to about 5 wt. % moisture.

3. The process of claim 1, wherein the ground coffee beans have an average particle size of about 0.1 mm to about 4 mm.

4. The process of claim 1, wherein the solid particulate product comprises at least about 50% ground coffee beans have an average particle size of about 0.1 mm to about 1 mm.

5. The process of claim 1, wherein the introducing of the heated air comprises supplying compressed heated air at a pressure within the range of from about 10 psig to about 100 psig.

6. The process of claim 1, wherein the introducing of the heated air comprises supplying compressed heated air at a pressure within the range of from about 15 psig to about 60 psig.

7. The process of claim 1, wherein the introducing of the heated air comprises supplying the heated air at a temperature within the range of about 300° F. to about 500° F.

8. The process of claim 1, wherein the introducing of the heated air comprises supplying the heated air at a temperature within the range of about 375° F. to about 425° F.

9. The process of claim 1, wherein the introducing of the heated air comprises supplying the heated air at a rate of within the range of from about 1,000 cubic feet per minute to about 10,000 cubic feet per minute.

10. The process of claim 1, wherein the introducing of the heated air comprises supplying the heated air at a rate within the range of from about 1,500 cubic feet per minute to about 3,000 cubic feet per minute.

11. The process of claim 1, further comprising screening the discharged solid particulate product; collecting ground coffee beans in the solid particulate product having particle sizes less than a predetermined size; and re-introducing coffee beans in the solid particulate product having particle sizes as large as or more than the predetermined size into the upper enclosure.

12. The process of claim 1, wherein the lower end of the enclosure communicates with a rotary valve permitting discharged of solid particulate product from the enclosure in a substantially air-tight manner.

13. The process of claim 1, further comprising exhausting moisture vapor released from the coffee beans during drying and roasting via the exhaust outlet.

14. A coffee bean heat treatment and grinding process, comprising:
introducing compressed heated air into an upper cylindrical enclosure wherein the heated air spirals along a downward path through the upper enclosure and into an adjoining lower enclosure having a truncated conical shape and a lower end, and the heated air flows back up and exits the upper enclosure via an exhaust outlet;
introducing into the upper enclosure green coffee beans which are entrained in the heated air spiraling downward through the upper and lower enclosures, wherein at least a portion of the green coffee beans are dried, roasted, and ground before reaching a lower end of the lower enclosure;
discharging a solid particulate product including dried, roasted and ground coffee beans from the lower end of the lower enclosure.

15. The process of claim 14, wherein the green coffee beans contain about 25 wt. % to about 35 wt. % moisture when introduced; and the dried, roasted and ground coffee beans contain about 3 wt. % to about 5 wt. % moisture.

16. The process of claim 14, wherein the ground coffee beans have an average particle size of about 0.1 mm to about 4 mm.

17. The process of claim 14, wherein the solid particulate product comprises at least about 50% ground coffee beans have an average particle size of about 0.1 mm to about 1 mm.

18. The process of claim 14, wherein the introducing of the heated air comprises supplying compressed heated air at a pressure within the range of from about 10 psig to about 100 psig.

19. The process of claim 14, wherein the introducing of the heated air comprises supplying compressed heated air at a pressure within the range of from about 15 psig to about 60 psig.

20. The process of claim 14, wherein the introducing of the heated air comprises supplying the heated air at a temperature within the range of about 300° F. to about 500° F.

21. The process of claim 14, wherein the introducing of the heated air comprises supplying the heated air at a temperature within the range of about 375° F. to about 425° F.

22. The process of claim 14, wherein the introducing of the heated air comprises supplying the heated air at a rate of within the range of from about 1,000 cubic feet per minute to about 10,000 cubic feet per minute.

23. The process of claim 14, wherein the introducing of the heated air comprises supplying the heated air at a rate within the range of from about 1,500 cubic feet per minute to about 3,000 cubic feet per minute.

24. The process of claim 14, further comprising screening the discharged solid particulate product; collecting ground coffee beans in the solid particulate product having particle sizes less than a predetermined size; and re-introducing coffee beans in the solid particulate product having particle sizes as large as or more than the predetermined size into the upper enclosure.

25. The process of claim 14, wherein the introducing of the heated air into the upper cylindrical enclosure occurs in a direction oriented generally tangentially to inner walls of the cylindrical enclosure.

26. The process of claim 14, wherein the lower end of the lower enclosure communicates with a rotary valve permitting discharged of solid particulate product from the lower enclosure in a substantially air-tight manner.

27. The process of claim 14, wherein the upper cylindrical enclosure has a substantially constant diameter of about 1 to about 10 feet, and the lower enclosure comprises a truncated conical shape having a maximum diameter size where the lower enclosure adjoins the cylindrical enclosure and the maximum diameter of the lower enclosure is substantially the same as the diameter of the cylindrical enclosure.

28. The process of claim 14, further comprising exhausting moisture vapor released from the coffee beans during drying and roasting via the exhaust outlet.
